(19) United States
(12) Patent Application Publication
(10) Pub. No.: US 2006/0247020 A1
(43) Pub. Date: Nov. 2, 2006

(54) Game machine operation authentication system and game machine

(76) Inventor: Kenichi Fujimori, Tokyo (JP)

Correspondence Address: JORDAN AND HAMBURG LLP, 122 EAST 42ND STREET, SUITE 4000, NEW YORK, NY, 10168, US

(21) Appl. No.: 11/356,864

(22) Filed: Feb. 16, 2006

(30) Foreign Application Priority Data
Feb. 17, 2005 (JP) 2005-041124

(51) Int. Cl. A63F 13/00

(52) U.S. Cl. 463/22; 463/20

(57) ABSTRACT

The present invention relates to a game machine operation authentication system provided with an authentication function which can be surely performed without use of a physical key and without connection to a network, and a game machine. The operation authentication system has a game machine 1 provided with a PCB box for performing control for a game and a USB memory required for operation authentication. The game machine 1 has a connection terminal to which a USB memory can be connected. Furthermore, the game machine 1 generates target data to be encoded with the use of the connected USB memory, instructs encodement of the generated target data, performs decode processing of the generated encoded data and determines permission or refusal of operation authentication based on the result of the decode processing. In the USB memory, an encodement program for encoding the target data to generate encoded data is stored.

The present disclosure relates to subject matters contained in Japanese Patent Application No. 2005-041124 filed on Feb. 17, 2005, which are expressly incorporated herein by reference in its entireties.

### BACKGROUND OF THE INVENTION

1. Field of the Invention

The present invention relates to a game machine operation authentication system provided with an authentication function for causing a game control unit for performing control for a game to operate, and a game machine.

2. Description of the Prior Art

There have been known various game machines such as a game machine enabling an image game using an image displayed on image display means, such as a liquid display device, to be played (a so-called video game machine), a slot machine, a pinball machine fitted with a slot machine mechanism and a pachinko game machine. As for the video game machine among these, there is disclosed, for example, in Japanese Patent Laid-Open No. 2004-73829, a game apparatus in which a game advances based on operation inputs by a player within a preset time limit and which gives time limit flexibility by permitting extension of the time limit subject to a predetermined condition.

Maintenance and inspection works (hereinafter referred to as “maintenance works”) for such kinds of game machine, such as replacement of parts, inspection, operation confirmation, and replacement of stored programs, are regularly or irregularly performed mainly by a staff member of the game hall, and the inside of the game machines is targeted by the maintenance works. Therefore, the door of such a game machine is usually locked with a key, and the maintenance works can be performed only when the staff member unlocks the game machine with a physical key so that an unauthorized act can be prevented from being performed against the inside of the game machine. However, there are problems that, since the physical key may be stolen and easily copied, it is difficult to completely prevent an unauthorized act against the inside of the game machine with the physical key, and that replacement of the lock on the game machine side is required when the key is lost or broken.

Accordingly, there is an idea that such a game machine is electronically locked with a storage medium such as a USB (universal serial bus) memory and an IC card or a dongle (a kind of hardware key used for preventing unauthorized copy of software, for example, such disclosed in Japanese Patent Laid-Open No. 2004-8799).

With regard to an apparatus to be used for electronic locking, there have been techniques related to a USB access key which enables access to a web page, authentication and display of a predetermined web page on a personal computer terminal to be automatically performed only by inserting the USB access key into a USB interface (see Japanese Patent Laid-Open No. 2003-216586, for example).

However, in the prior-art technique described in Japanese Patent Laid-Open No. 2003-216586, it is required to access a separate server from equipment (a computer) to be authenticated via a communication line in order to perform authentication. Therefore, it is required to connect a game machine to be authenticated to a network to perform authentication with the use of a USB access key. Furthermore, even if a game machine provided with the function described in Japanese Patent Laid-Open No. 2003-216586 is connected to a network, authentication or maintenance works cannot be performed in the case of a communication impossibility state in which access to a server from the game machine is impossible due to some cause such as communication line abnormality.

The present invention has been made to solve the problems described above, and its object is to provide a game machine operation authentication system provided with an authentication function which can be surely performed without use of a physical key and without connection to a network, and a game machine.

### SUMMARY OF THE INVENTION

In order to solve the above problem, the present invention is a game machine operation authentication system, comprising: a game machine provided with a game control unit for performing control for a game; and an authentication device required for operation authentication for causing the game control unit to operate; wherein: the game machine has: a connection terminal to which the authentication device is to be connected; target data generation means (corresponding to a CPU functioning as a target data generation unit) for generating target data to be encoded with the use of the authentication device connected to the connection terminal; encodement instruction means (corresponding to a CPU functioning as an encodement instruction unit) for instructing encodement of the target data generated by the target data generation means; decode means (corresponding to a CPU functioning as an decode unit) for performing decode processing of encoded data generated with the target data in accordance with an instruction from the encodement instruction means; and determination means (corresponding to a CPU functioning as a determination unit) for determining permission or refusal of the operation authentication based on the result of the decode processing by the decode means; and the authentication device has encodement program storage means in which an encodement program for encoding the target data generated by the game machine to generate the encoded data is stored.

This operation authentication system requires connection of an authentication device to a game machine, encodement of target data with the connected authentication device, and decode of the generated encoded data to be performed. Therefore, it is not necessary to use a physical key or connect the game machine to a network to perform operation authentication.

It is preferable that, in the game machine operation authentication system described above, the target data generation means generates time data indicating the current time of the game machine as target data; the game machine further comprises time difference calculating means (corresponding to a CPU functioning as a time difference calculating unit) for determining time difference between decoded data which has been decoded by the decode means and decode time data indicating the time when the decode processing by the decode means has been performed; and the determination means determines that authentication is permitted when the time difference determined by the time difference calculating means is within an effective period and that authentication is refused when the time difference is not within the effective period.

Thereby, it is added as a condition for permitting operation authentication that the decode processing can be performed within the effective period.

Furthermore, the present invention provides a game machine provided with a game control unit for performing control for a game and constituting a game machine operation authentication system together with a authentication device required for operation authentication for operating the game control unit, comprising: a connection terminal to which the authentication device is to be connected; target data generation means (corresponding to a CPU functioning as a target data generation unit) for generating target data to be encoded with the use of the authentication device connected to the connection terminal; encodement instruction means (corresponding to a CPU functioning as an encodement instruction unit) for instructing encodement of the target data generated by the target data generation means; decode means (corresponding to a CPU functioning as an decode unit) for performing decode processing of encoded data generated with the target data in accordance with an instruction from the encodement instruction means; and determination means (corresponding to a CPU functioning as a determination unit) for determining permission or refusal of the operation authentication based on the result of the decode processing by the decode means.

It is preferable that the target data generation means of this game machine generates time data indicating the current time as target data; and the game machine further comprises time difference calculating means (corresponding to a CPU functioning as a time difference calculating unit) for determining time difference between decoded data which has been decoded by the decode means and decode time data indicating the time when the decode processing by the decode means has been performed; and the determination means determines that authentication is permitted when the time difference determined by the time difference calculating means is within an effective period and that authentication is refused when the time difference is not within the effective period.

As described above, according to the present invention, there is obtained a game machine operation authentication system provided with an authentication function to be surely performed without using a physical key and without connecting to a network, and a game machine.

### BRIEF DESCRIPTION OF THE DRAWINGS

FIG. 1 is a system configuration diagram of a game system provided with multiple game machines according to the present invention;

FIG. 2 is a perspective view showing the multiple game machines and card vending machines;

FIG. 3 is a perspective view showing the entire configuration of the game machine;

FIG. 4 is a block diagram of the game machine mainly showing the internal configuration thereof;

FIG. 5(A) is a perspective view showing the internal configuration of the game machine with a part thereof omitted, and FIG. 5(B) is a system configuration diagram of an operation authentication system;

FIG. 6(A) is a front view showing the external configuration of a USB memory, and FIG. 6(B) is a block diagram showing the internal configuration thereof;

FIG. 7 is a flowchart showing the operation procedure for encoded data generation processing;

FIG. 8 is a flowchart showing the operation procedure for recognition processing;

FIG. 9 is a flowchart showing the operation procedure for encodement processing;

FIG. 10 is a flowchart showing the operation procedure for authentication processing; and

FIG. 11 is a flowchart showing the operation procedure for decode processing.

The accompanying drawings, which are incorporated in and constitute a part of the specification, illustrate embodiments of the invention, and together with the general description given above and the detailed description of the embodiments given below, serve to explain the principles of the invention.

### DESCRIPTION OF THE PREFERRED EMBODIMENTS

An embodiment according to the present invention will be described below in detail with reference to drawings.

An embodiment of the present invention will be described below. The same reference numerals will be used for the same components, and duplicated explanation will be omitted.

(Entire Configuration of a Game System)

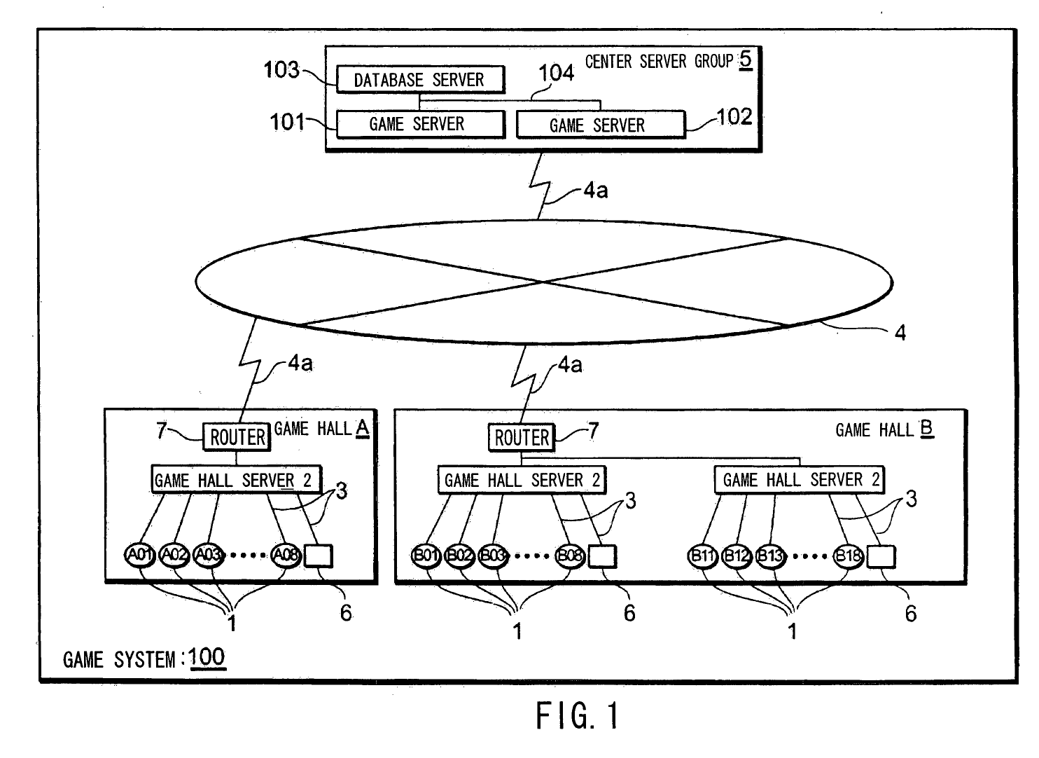

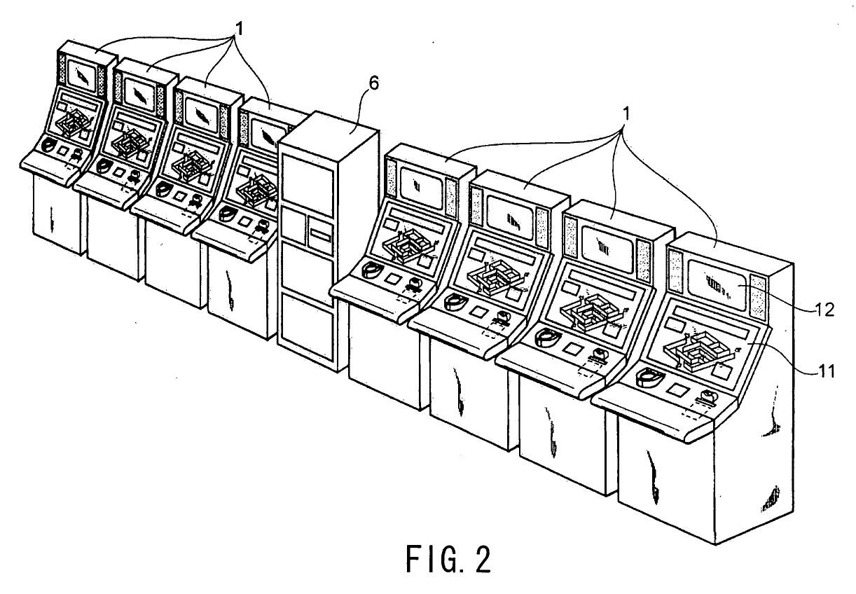

FIG. 1 is a system configuration diagram of a game system 100 provided with multiple game machines 1 according to the present invention, and FIG. 2 is a perspective view showing the multiple game machines 1 and card vending machines 6. The game system 100 has a total of three game hall servers 2, one installed in a game hall A and two in a game hall B; the multiple (eight in this embodiment) game machines 1 and a card vending machine 6 for issuing an ID card 17 which are communicatively connected to each game hall server 2 via each of dedicated lines 3; in-store routers 7 provided for the respective game halls A and B; and a center server group 5 connected via the in-store routers 7, communication lines 4a and the Internet 4.

In each of the game halls A and B, the game hall server(s) 2, the game machines 1 and the card vending machine(s) 6 are connected via the dedicated lines 3 to form an in-store LAN (local area network), and the in-store LAN is connected to the Internet 4 via the in-store router 7.

(Configuration of a Game Machine)

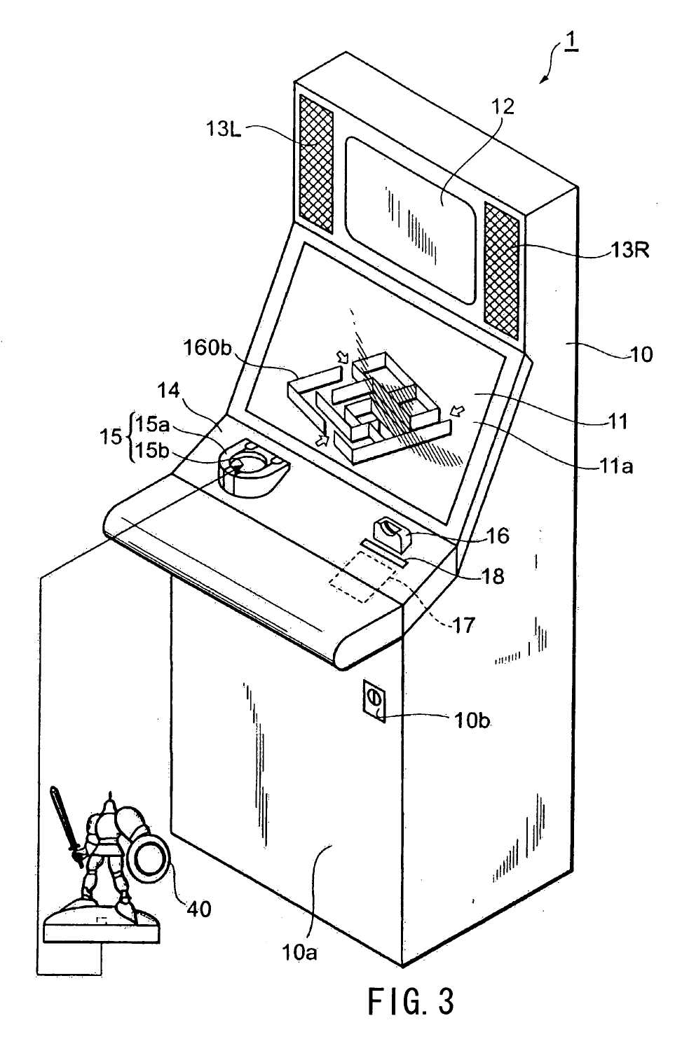

The game machine 1 is a game machine according to the embodiment of the present invention, and it has means for displaying a character image indicating a character that acts in response to an operation by a player, as a game image used for a game, and is configured so that an image game can be played in which the character is caused to perform an act in response to an operation by the player. In the game machine 1 in this embodiment, a game can be played in which the character moves in a labyrinth along a route selected by the player, fights with other characters to deprive them of items which they have, and defeat the final target character after collecting all the items (hereinafter the game is referred to as a “labyrinth battle game”). (As shown in FIG. 3, while this labyrinth battle game is played, there is displayed an image provided with a labyrinth display section 160b which forms a labyrinth in which the character moves, on a main display 11 to be described later.)

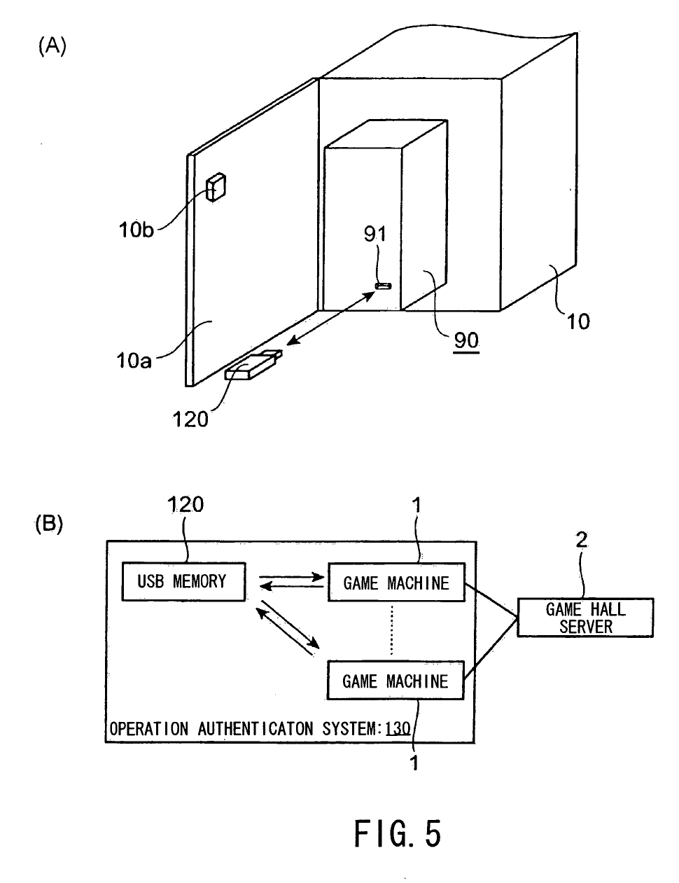

As shown in FIG. 5(B), each of the game machines 1 constitutes an operation authentication system 130 which the present invention is characterized in, together with a USB memory 120 to be described later.

As shown in FIG. 3, the game machine 1 has the main display 11 provided with a liquid display device as display means, on the front face of a body 10. Furthermore, it has a sub-display 12 similarly provided with a liquid display device at the upper part of the main display 11. On the both sides of the sub-display 12, there are arranged speakers 13L and 13R for outputting voices making the game more excited.

On the main display 11, a game image (for example, an image having the labyrinth display section 160b) corresponding to each stage of the game is displayed. On the sub-display 12, an image corresponding to a particular stage of the play is to be displayed.

Furthermore, the game machine 1 has an operation panel 14 at the lower part of the main display 11, and a reading unit 15 is arranged at the left side of this operation panel 14. On the right side thereof, there are arranged a coin slot 16 through which coins (game media such as hard cash and game medals) required for playing the game are to be thrown in, and a cards lot 18 thorough which the ID card 17 is to be inserted.

Furthermore, the game machine 1 is configured so that a front panel 10a below the operation panel 14 of the body 10 can be freely opened and closed, and the front panel 10a can be locked and unlocked by inserting a predetermined physical key not shown into a lock section 10b and performing a locking or unlocking operation. A PCB box 90 to be described later is incorporated in the body 10 as shown in FIG. 5(A), and the PCB box 90 can be visually checked by opening the front panel 10a.

The reading unit 15 has a seat mounting section 15a fixed on the surface of the operation panel 14 and a reading section 15b. The seat mounting section 15a is configured so that a FIG. 40 used for the labyrinth battle game to be played on the game machine 1 can be fit therein. The reading section 15b is arranged in the hole of the seat mounting section 15a and provided with an IC chip reader not shown. With the IC chip reader, recorded information is read from an IC chip included in the mounted FIG. 40.

Each of the game machines 1 constituting the game system 100 is given a machine ID specific thereto. This machine ID consists of a server ID specific to each game hall server 2 and an ID specific to each game machine 1. For example, in the case of each game machine 1 arranged in the store A, the machine ID's are A01, A02, A03, and so on.

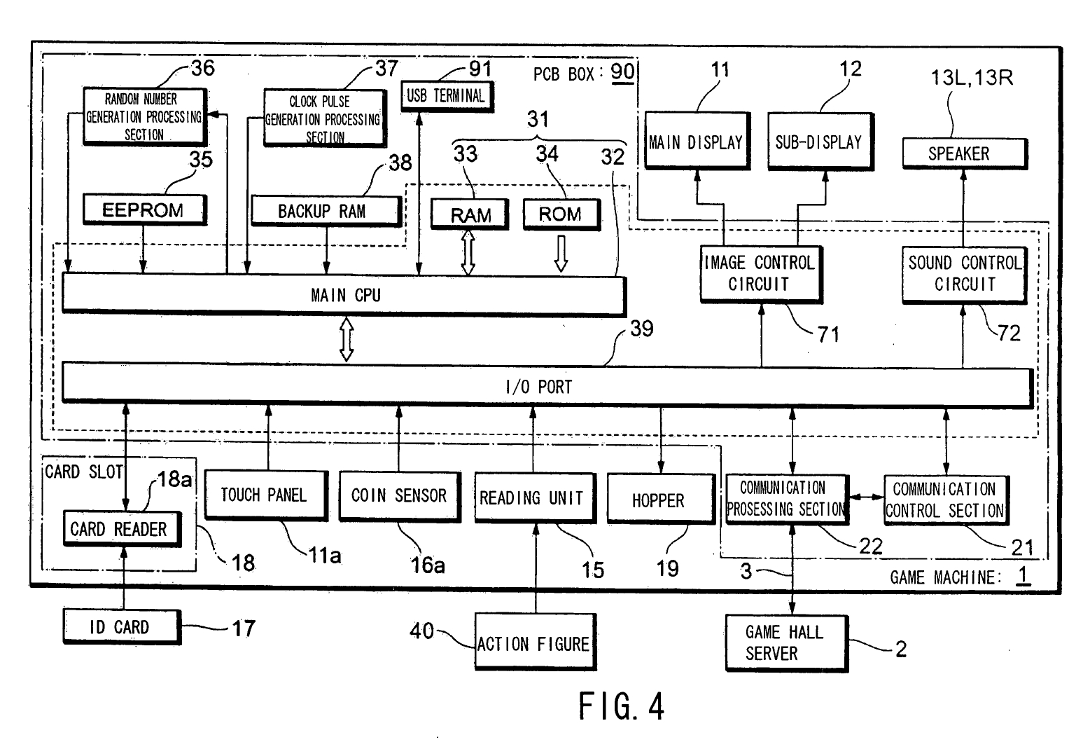

FIG. 4 is a block diagram of the game machine 1 mainly showing the internal configuration thereof. The game machine 1 has multiple components with a microcomputer 31 as the center thereof.

The microcomputer 31 has a main CPU (central processing unit) 32, a RAM (random access memory) 33 and a ROM (read-only memory) 34. The main CPU 32 operates in accordance with programs stored in the ROM 34. It inputs signals from each component provided on the operation panel 14 via an I/O port 39, and inputs and outputs signals to and from other components to control the operation of the entire game machine 1. In the RAM 33, there are stored data or programs to be used when the main CPU 32 operates (in this embodiment, application data and game data to be described later). In addition, a decode program corresponding to an encodement program to be described later is also stored. This decode program can decode and decode encoded data which has been encoded with the encodement program, with the use of an encodement key common to the encodement program. In the ROM 34, there are stored a control program to be executed by the main CPU 32 and permanent data.

Furthermore, the game machine 1 has an EEPROM 35, a random number generation processing section 36, a clock pulse generation processing section 37 and a backup RAM 38. In the EEPROM 35, there is stored information such as the name of the game to be played on each game machine 1 in the game system 100 (in this embodiment, the labyrinth battle game described above), which is to be used for determination of equipment. The random number generation processing section 36 operates in accordance with an instruction from the main CPU 32 to generate random numbers with in a predetermined range, extracts any random number from among the generated random numbers and inputs the extracted random number into the main CPU 32. The clock pulse generation processing section 37 generates a reference clock for causing the main CPU 32 to operate, and inputs a signal obtained by dividing the reference clock by a predetermined frequency into the main CPU 32. In the backup RAM 38, there is stored monitoring information such as opening/closing and removal information (information about opening and closing of the front panel 10a), ROM removal information (information about mounting or removal (insertion or pulling out) of ROM 34), IDE cable removal information (information about whether an IDE cable has been fixed or removed (insertion or pulling out)), and satellite ID information (information about whether the satellite ID information has been changed or not).

Furthermore, the game machine 1 has a touch panel 11a, a coin sensor 16a, a card reader 18a, a hopper 19, a communication control section 21 and a communication processing section 22. Furthermore, it also has an image control circuit 71 and a sound control circuit 72.

The touch panel 11a is provided so that it covers the display screen of the main display 11. It detects the position of the place where the finger of a player touches and inputs a position signal corresponding to the detected position into the main CPU 32. The coin sensor 16a detects coins thrown in through the coin slot 16 and outputs a detection signal corresponding to the detection to the main CPU 32. The card reader 18a reads card information such as a player ID recorded in an ID card 17 inserted into the card slot 18 and inputs the read card information into the main CPU 32. The hopper 19 discharges game media such as coins and medals.

The communication control section 21 operates in accordance with an instruction from the main CPU 32 and controls connection and disconnection of a line for communication with the game hall server 2. The communication processing section 22 operates in accordance with an instruction from the communication control section 21, and performs sending and receiving of data via the dedicated line 3.

The image control circuit 71 controls image display on each of the main display 11 and the sub-display 12 and displays various images such as images indicating characters on the main display 11 and the sub-display 12.

The sound control circuit 72 inputs voice signals for outputting voices from the speakers 13L and 13R into the speakers 13L and 13R. From the speakers 13L and 13R, for example, voices for making the game more exciting are outputted at appropriate timings after the game starts.

The PCB box 90 of the game machine 1 contains each of the components, the microcomputer 31 to the backup RAM 38 described above, the I/O port 39, the image control circuit 71, the sound control circuit 72, the communication control section 21 and the communication processing section 22. This PCB box 90 is a game control unit according to the present invention, and it is formed as a rectangular parallelepiped with a size allowing the unit to be contained in the portion lower than the operation panel 14 of the body 10. In the PCB box 90, there are contained components for performing control for the game, such as control of the progress of the game, control of image display on each of the main display 11 and the sub-display 12 and control of discharge of game media from the hopper 19. At the front side of the PCB box 90, there is provided a USB terminal 91 to which a USB memory 120 described later can be connected, as a connection terminal according to the present invention. This USB terminal 91 is connected to the main CPU 32 (see FIG. 4).

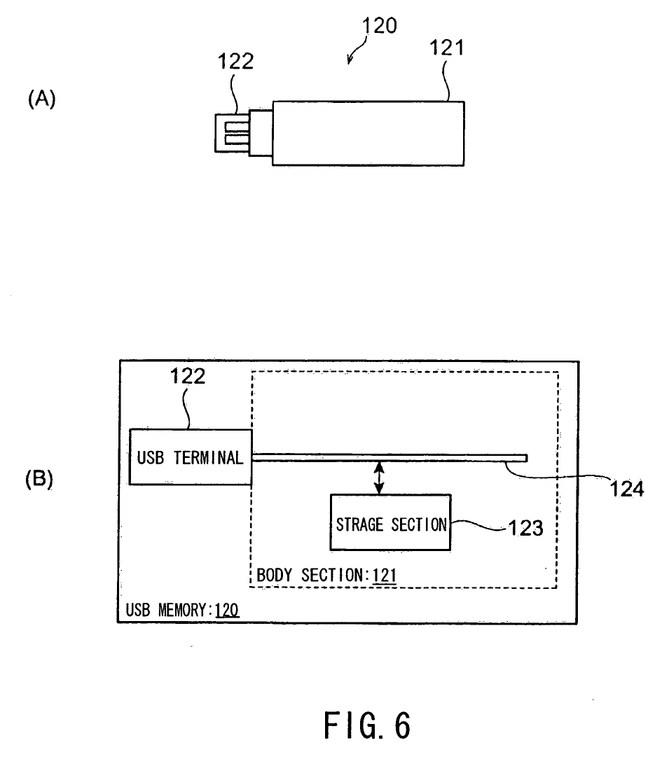

The USB memory 120 is an authentication device according to the present invention and it has an external configuration as shown in FIG. 6(A) and a size allowing it to be carried. This USB memory 120 has a body section 121 and a USB terminal 122 which protrudes from one end of the body section 121 and can be connected to the USB terminal 91 of the PCB box 90. As shown in FIG. 6(B), the body section 121 has at least a storage section 123 and includes a bus 124 connecting the USB terminal 122 and the storage section 123. The storage section 123 is encodement program storage means according to the present invention and is configured by a non-volatile data storage section such as a flash memory. An encodement program to be described later is stored therein.

(Configuration of the Game Hall Server 2)

The game hall servers 2 perform sending and receiving of data with the game machines 1 installed in the game halls A and B via the dedicated lines 3, and relays sending (download) of application data to each of the game machines 1 and sending and receiving of data among the game machines 1 or to and from the center server group 5. The application data includes various data (such as image data for the game) to be used for playing the labyrinth battle game on the game machines 1.

The center server group 5 has multiple game servers installed corresponding to respective games (in FIG. 1, two game servers 101 and 102) and a database server 103. The game servers are connected with each other via a dedicated line 104 to form a LAN, and the LAN is connected to the Internet 4 via a router not shown.

The game server 101 is installed to execute the labyrinth battle game and performs sending and receiving of data to and from each game hall server 2 via the Internet 4. The game server 101 receives entry data from each game machine 1, receives a player's participation into the labyrinth battle game (entry), updates players' participation information, determines a player to be a counterpart, and then sends the result to the database server 103.

The game server 102 is installed to execute another game and has the same configuration as the game server 101 though stored data and programs are different.

The database server 103 performs sending and receiving of data to and from each game hall server 2 via the Internet 4 and has a data storage section not shown in which player ID's, passwords used for authentication of players, the kinds of game and game data are stored.

By each player setting a FIG. 40 to be used by him in the reading unit 15 of each game machine 1 to cause a figure ID specific to the FIG. 40 to be read, the figure ID corresponding to the read FIG. 40 is sent to the database server 103 from the game machine 1. In the database server 103, an ID management file, in which multiple corresponding figure ID's can be associated with one player ID sent from the game machine 1 and stored, is formed in a data storage section not shown.

(Content of Operation of an Operation Authentication System)

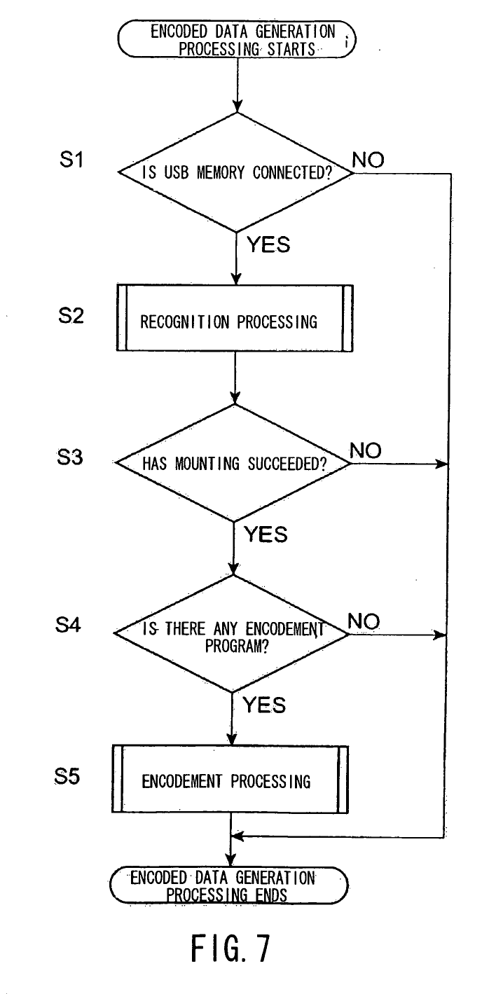

Next, description will be made on the content of the operation of the operation authentication system 130, which is configured by the game machines 1 and the USB memory 120, with reference to flowcharts shown in FIGS. 7 to 10.

FIG. 7 is a flowchart showing the operation procedure for encoded data generation processing by the operation authentication system 130 to be performed on the game machine 1. In the game machine 1, the encoded data generation processing and succeeding authentication processing are being performed by the main CPU 32.

In the game machine 1, when power is on, the encoded data generation processing starts. (Other than this, for example, the processing may be started by a sub-routine call from a main routine.) When the encoded data generation processing starts, the main CPU 32 proceeds to step 1 and determines whether or not the USB memory 120 is connected to the USB terminal 91 (whether or not the USB terminal 122 is inserted). If it is not connected, then the main CPU 32 generates data indicating that generation has failed and terminates the processing. If it is connected, then the main CPU 32 proceeds to step 2 and performs the recognition processing. Then, for performing the operation authentication according to the present invention to operate the PCB box 90, as a part of maintenance works such as operation confirmation or change of a program and execution of a test game, it is necessary to first connect the USB memory 120 to the PCB box 90 of the game machine 1. Therefore, an operator opens the front panel 10a using a predetermined key and inserts the USB terminal 122 of the USB memory 120 into the USB terminal 91.

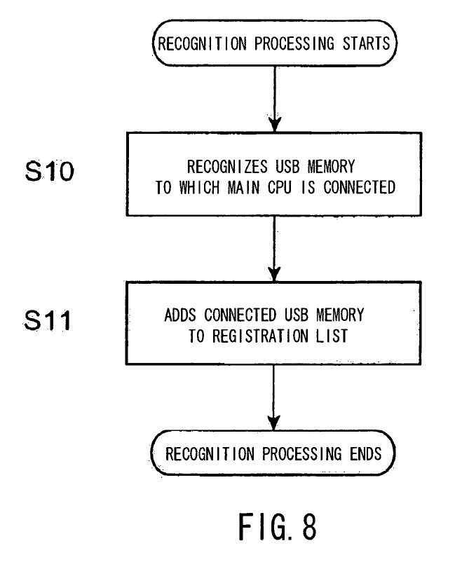

When the recognition processing is started, the main CPU 32 proceeds to step 10 as shown in FIG. 8 and operates in accordance with a control program (for example, a USB device driver incorporated in the OS responsible for the basic operation of the main CPU 32) stored in the ROM 34 and recognizes the USB memory 120 connected to the PCB box 90 as a removable drive. At the succeeding step 11, the main CPU 32 adds the USB memory 120 to a hardware registration list. In this way, the connected USB memory 120 is mounted as a removable disk and treated as one of the components of the PCB box 90, and encodement processing at step 5 to be described later is ready to be performed. When the step 11 is executed, the recognition processing ends. Then, the main CPU 32 returns to FIG. 7 and proceeds to step 3. At step 3, the main CPU 32 determines whether mounting of the USB memory 120 has succeeded or failed. In the case of success, the main CPU 32 proceeds to step 4. In the case of failure, however, the encoded data generation processing ends.

Next, when having proceeded to step 4, the main CPU 32 determines whether or not the encodement program is stored in the storage section 123 of the USB memory 120. If the encodement program is stored (that is, if the connected USB memory is the USB memory 120 constituting the operation authentication system 130), then the main CPU 32 proceeds to step 5. If the encodement program is not stored, the encoded data generation processing ends.

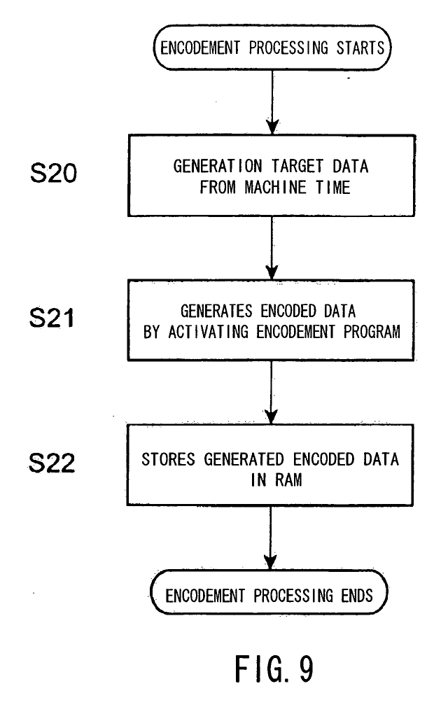

When having proceeded to step 5, the main CPU 32 operates as target data generation means and encodement instruction means. When the encodement processing is started, the main CPU 32 proceeds to step 20 shown in FIG. 9, obtains time data indicating the current time from time measuring means not shown which measures machine time of the game machine 1, and sets the time data as target data to be encoded. Then, the main CPU 32 proceeds to step 21 and instructs encodement of the target data. Then, the encodement program stored in the storage section 123 of the connected USB memory 120 is activated in response to an instruction from the main CPU 32, and encoded data, for example, of 48 bits is generated by encoding the target data generated at step 20 with an encodement key. The generated encoded data is stored in the RAM 33 at the succeeding step 22.

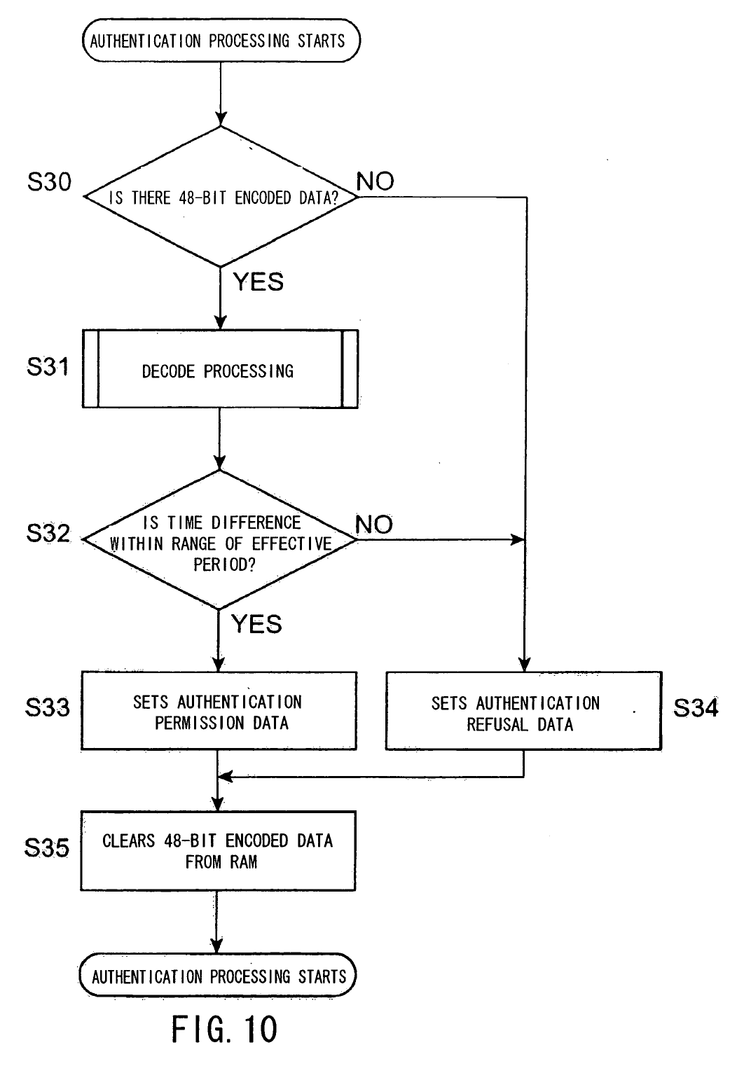

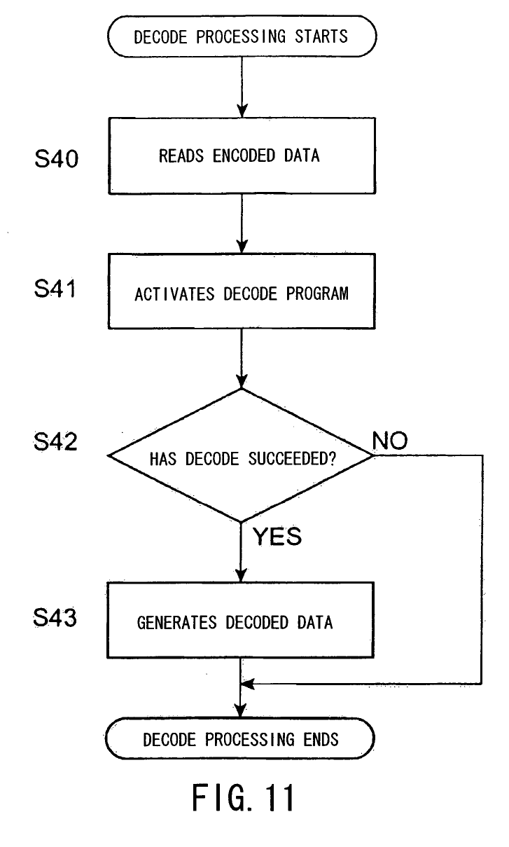

Then, when the encodement processing ends, the authentication processing is performed in accordance with the flowchart shown in FIG. 10. In this case, when having started the authentication processing, the main CPU 32 proceeds to step 30 and determines whether or not the 48-bit encoded data (that is, the encoded data generated at step 21) is stored in the RAM 33. If the encoded data is stored, the main CPU 32 proceeds to step 31. Otherwise, the main CPU 32 proceeds to step 34. When having proceeded to step 31, the main CPU 32 operates as decode means in accordance with the decode program stored in the RAM 33 and performs decode processing for decoding the encoded data generated at step 21 with a common encodement key in accordance with the flowchart shown in FIG. 11. When having started the decode processing, the main CPU 32 proceeds to step 40 and reads the encoded data stored in the RAM 33. At the succeeding step 41, the main CPU 32 activates the decode program stored in the RAM 33. Then, the main CPU 32 proceeds to step 42, where it determines whether or not the encoded data has been decoded (decoded) with the activated decode program. At step 41, if the decode cannot be performed for some reason, the decode processing ends. If the decode (decoding) has succeeded, then the main CPU 32 proceeds to the next step 43, where decoded data, which is the decoded encoded data, is generated. The generated, decoded data is decoded time data, the encodement time data which has been decoded.

When the decode processing ends, the main CPU 32 returns to FIG. 10 and proceeds to step 32, where it reads the current time from the measuring means not shown to generate decode time data indicating the time when the decode processing has completed. (The decode time data may be any data indicating the time when the decode processing has been performed, and the current time may be read when the decode processing is completed or during execution of the decode processing.) Then, the main CPU 32 operates as time difference calculating means according to the present invention to calculate time difference between the decoded data (decode time data) obtained by the decode processing and the decode time data obtained by the read current time, and further operates as determination means to determine whether the operation authentication is permitted or not based on the result of the decode processing. In this embodiment, the main CPU 32 determines whether or not the time difference is within the range of an effective period for determining whether the operation authentication is permitted or not (though the effective period is described as one minute in this embodiment, it is not limited to one minute). Here, the calculated time difference is within the effective period, then the main CPU 32 proceeds to step 33. However, if it is beyond the range, the main CPU 32 proceeds to step 34. When having proceeded to step 33, the main CPU 32 sets authentication permission data for permitting the operation authentication. When having proceeded to step 34, the main CPU 32 sets authentication refusal data indicating that the operation authentication is not permitted. Then, the main CPU 32 proceeds to step 35, where it clears the encoded data stored in the RAM 33 and terminates the authentication processing.

When this authentication processing ends, the authentication permission data or the authentication refusal data is set. The game machine 1 requires that the authentication permission data is set in order to operate the PCB box 90 as a part of maintenance works. That is, the authentication permission data is read by initial processing (not shown) to be performed during the maintenance works, and the succeeding processing is performed after the authentication permission data has been read. If the authentication permission data cannot be read (that is, in the case where the authentication refusal data is set), the succeeding processing is not performed.

As described above, in the game system 100, in order to operate the PCB box 90 as a part of maintenance works, connection of the USB memory 120 to the PCB box 90 is required, and furthermore, it is also required that encoded data is generated with the use of the USB memory 120 and decoding (decode) of the generated encoded data (the encoded time data in the description above) is performed within an effective period.

Therefore, the work for operating the PCB box 90 as a part of maintenance works requires that the USB memory 120 in which the encodement program according to the present invention is stored should be used, and the work cannot be performed with a different USB memory in which the encodement program is not stored or with a different USB memory in which a different encodement program not corresponding to the decode program stored in the game machine 1 is stored. Therefore, the operation authentication can be performed only when the USB memory 120 and the game machine 1 in which an encodement program and a decode program corresponding to each other are stored, respectively, can be used. That is, the conditions which allow the maintenance works to be performed are strictly restricted, and the security level is high. Since it is required to perform both of analysis of the encodement program in the USB memory 120 and analysis of the decode program in the game machine 1 to perform an unauthorized act, the security level is higher. Furthermore, even if both analyses can be performed, time is limited to have the operation authentication permitted. Thus, the security level is much higher.

The operation authentication is performed not with the use of a physical key but with the use of the USB memory 120. Therefore, if the USB memory 120 is lost, broken or stolen, all that has to be done is to update both of the encodement and decode programs, for example, by downloading a decode program corresponding to a different encodement program obtained by changing the algorithm of the encodement processing, via the network of the game system 100, and troublesome works such as replacement of a physical key and lock is not required. Furthermore, since authentication is performed by connecting the USB memory 120 to the PCB box 90, it is not necessary to connect the game machine 1 to any other machines, i.e., another piece of equipment such as a server via the network to perform the operation authentication. Therefore, even if communication between the game machine 1 and the game hall server 2 or the game system 100 becomes impossible, the operation authentication can be performed, and the authentication function is secure.

For example, when the game system 100 is operated, there may be a case where, because the business entity of the game system 100 consigns only the operation of the configuration (the game hall servers 2 and the game machines 1) in the game halls A and B to another business entity, the business entity who operates the game halls A and B is different from the operator of the center server group 5. In such a case, by performing the operation authentication by means of the operation authentication system 130 and by allowing only the operator of the center server group 5 to carry the USB memory 120 and not allowing the staff members of the game halls A and B to carry it, it is possible to restrict the range of maintenance works for the PCB box 90. Thus, even if the staff members of the game halls A and B belong to a different business entity, it is possible to surely prevent an unauthorized act (for example, unauthorized execution of a test mode of the game) to be performed for the PCB box 90 by such staff members.

In the above description, though a game machine 1 on which the labyrinth battle game can be played has been described as an example, the present invention can be applied to a game machine on which a different image game can be played. For example, there is a game machine on which a team play can be simulated with the use of a figure or a cassette corresponding to each player, in a game in which multiple players appear, such as a baseball game and a soccer game.

Though the game machine 1 is provided with the main display 11 and the sub-display 12 for displaying game images, the main display 11 and the sub-display 12 may be separately provided.

In the above embodiment, a case where the USB memory 120 is used as an authentication device has been described as an example. However, other devices having information storage means (for example, an IC card) maybe used as the authentication device. Control means may be provided in addition to the storage means, and encoded data may be generated by the control means operating in accordance with an instruction from the main CPU 32 of the game machines 1 and activating the encodement program stored in the storage means. In such a case, target data is outputted from the game machine 1 to the authentication device, and the generated encoded data is outputted from the authentication device to the game machines 1 or read by the game machine 1 from the authentication device

The operation authentication may be applicable to other purposes different from the maintenance works if operation of the PCB box 90 is intended.

Additional advantages and modifications will readily occur to those skilled in the art. Therefore, the invention in its broader aspects is not limited to the specific details or representative embodiments shown and described herein. Accordingly, various modification may be made without departing from the spirit or scope of the general inventive concept as defined by the appended claims and their equivalents.

What is claimed is:

1. A game machine operation authentication system, comprising:
a game machine provided with a game control unit for performing control for a game; and
an authentication device required for operation authentication for causing the game control unit to operate;
wherein:
the game machine has:
a connection terminal to which the authentication device is to be connected;
a target data generation unit for generating target data to be encoded with the use of the authentication device connected to the connection terminal;
an encodement instruction unit for instructing encodement of the target data generated by the target data generation unit;
a decode unit for performing decode processing of encoded data generated with the target data in accordance with an instruction from the encodement instruction unit; and
a determination unit for determining permission or refusal of the operation authentication, based on a result of the decode processing by the decode unit,
wherein:
the authentication device has the encodement program storage unit in which an encodement program for encoding the target data generated by the game machine to generate the encoded data is stored.

2. The game machine operation authentication system according to claim 1, wherein:
when the authenticate device becomes unusable, a decode program used by the decode unit is changed to other decode program corresponding to an encodement program stored in a new authenticate device used instead of the unusable authenticate device.

3. The game machine operation authentication system according to claim 1, wherein:
the game machine is not connected to any other machines in order to perform the operation authentication.

4. The game machine operation authentication system according to claim 1, wherein:
the authentication device further comprises control unit generating the encoded data by using the encodement program stored in the encodement program storage unit.

5. The game machine operation authentication system according to claim 1, wherein:
the target data generation unit generates the target data using time data indicating the current time of the game machine,
the game machine further comprises time difference calculating unit for determining time difference between decoded data which has been decoded by the decode unit and decode time data indicating the time when the decode processing by the decode unit has been performed, and
the determination unit determines that authentication is permitted when the time difference determined by the time difference calculating unit is within an effective period and that authentication is refused when the time difference is not within the effective period.

6. The game machine operation authentication system according to claim 5, wherein:
when the authenticate device becomes unusable, a decode program used by the decode unit is changed to other decode program corresponding to an encodement program stored in a new authenticate device used instead of the unusable authenticate device.

7. The game machine operation authentication system according to claim S, wherein:
the game machine is not connected to any other machines in order to perform the operation authentication.

8. The game machine operation authentication system according to claim 5, wherein:
the authentication device further comprises control unit generating the encoded data by using the encodement program stored in the encodement program storage unit.

9. A game machine provided with a game control unit for performing control for a game and constituting a game machine operation authentication system together with an authentication device required for operation authentication for operating the game control unit, comprising:
a connection terminal to which the authentication device is to be connected;
a target data generation unit for generating target data to be encoded with the use of the authentication device connected to the connection terminal;
an encodement instruction unit for instructing encodement of the target data generated by the target data generation unit;
a decode unit for performing decode processing of encoded data generated with the target data in accordance with an instruction from the encodement instruction unit; and
a determination unit for determining permission or refusal of the operation authentication based on the result of the decode processing by the decode unit.

10. The game machine according to claim 9, wherein:
when the authenticate device becomes unusable, a decode program used by the decode unit is changed to other decode program corresponding to a encodement program stored in a new authenticate device used instead of the unusable authenticate device.

11. The game machine according to claim 9, wherein:
the game machine is not connected to any other machines to perform the operation authentication.

12. The game machine according to claim 9, wherein:
the authentication device further comprises control unit generating the encoded data by using the encodement program stored in the encodement program storage unit.

13. The game machine according to claim 9, wherein:
the game machine further comprises time difference calculating unit for determining time difference between decoded data which has been decoded by the decode unit and decode time data indicating the time when the decode processing by the decode unit has been performed,
the target data generation unit generates the target data using time data indicating the current time, and
the determination unit determines that authentication is permitted when the time difference determined by the time difference calculating unit is within an effective period and that authentication is refused when the time difference is not within the effective period.

14. The game machine according to claim 13, wherein:
when the authenticate becomes unusable, a decode program used by the decode unit is changed to other decode program corresponding to a encodement program stored in a new authenticate device used instead of the unusable authenticate device.

15. The game machine according to claim 13, wherein:
The game machine is not connected to any other machines to perform the operation authentication.

16. The game machine according to claim 13, wherein:
the authentication device further comprises control unit generating the encoded data by using the encodement program stored in the encodement program storage unit.
